(19) United States
(12) Patent Application Publication
(10) Pub. No.: US 2022/0027436 A1
(43) Pub. Date: Jan. 27, 2022

(54) ANOMALY FACTOR ESTIMATION METHOD, ANOMALY FACTOR ESTIMATING DEVICE, AND PROGRAM

(71) Applicant: MITSUBISHI HEAVY INDUSTRIES, LTD., Tokyo (JP)

(72) Inventors: Masato SHIDA, Tokyo (JP); Takashi SONODA, Tokyo (JP); Shintaro KUMANO, Tokyo (JP)

(21) Appl. No.: 17/347,966

(22) Filed: Jun. 15, 2021

(30) Foreign Application Priority Data
Jul. 22, 2020 (JP) 2020-125085

(51) Int. Cl. G06F 17/18

(52) U.S. Cl. CPC G06F 17/18

(57) ABSTRACT

An anomaly factor estimation method includes the steps of: calculating, based on a factor table indicating an occurrence frequency of each of factors for each of events, a prior probability that is a probability for each factor to occur; calculating a posterior probability that is a probability for a certain event to be caused by a certain factor; and multiplying the posterior probability by a weighting coefficient relating to a signal-to-noise ratio gain value of a sensor measurement value, and calculating an index indicating an occurrence probability for each combination of the factors and the events.

### CROSS-REFERENCE TO RELATED APPLICATIONS

This application claims the benefit of priority to Japanese Patent Application Number 2020-125085 filed on Jul. 22, 2020. The entire contents of the above-identified application are hereby incorporated by reference.

### TECHNICAL FIELD

The disclosure relates to an anomaly factor estimation method, an anomaly factor estimating device, and a program.

### RELATED ART

A variety of apparatuses are used in power generation facilities, boilers, gas turbines, chemical plants, and the like. There is a demand for detecting an anomaly (e.g., fault or fault precursors) of these apparatuses and estimating the factors for the anomaly.

For example, JP 2006-99298 A discloses an apparatus fault diagnostic method (estimation method) for estimating a fault factor and a fault site using a fault tree (FT) diagram including a plurality of factors and a weighting point for each factor based on know-how of a technician. Also known is an estimation method in which an anomaly of an apparatus is detected using the Mahalanobis-Taguchi method, and an occurrence event and a factor of the anomaly are estimated by referring to the signal-to-noise ratio gain value of the sensor measurement value that contributed to an increase in the Mahalanobis distance.

### SUMMARY

The above-described conventional estimation methods are methods for estimating an anomaly factor by determining the reliability of each factor and selecting a reliable factor from among the factors. In practice, however, an anomaly of the apparatus may occur due to interaction among a plurality of factors, and a plurality of factors may coexist as factors for an anomaly. Therefore, estimating anomaly factors based on computation results for each factor (absolute evaluation) may decrease the estimation accuracy for anomaly factors.

In light of the foregoing, an object of the present disclosure is to provide an anomaly factor estimation method and the like capable of improving the estimation accuracy for anomaly factors.

An anomaly factor estimation method according to the present disclosure includes the steps of:

calculating, based on a factor table indicating an occurrence frequency of each of factors for each of events, a prior probability that is a probability for each factor to occur;

calculating a posterior probability that is a probability for a certain event to be caused by a certain factor; and

multiplying the posterior probability by a weighting coefficient relating to a signal-to-noise ratio gain value of a sensor measurement value, and calculating an index indicating an occurrence probability for each combination of the factors and the events.

An anomaly factor estimating device according to the present disclosure includes:

a prior probability calculating unit configured to calculate, based on a factor table indicating an occurrence frequency of each of factors for each of events, a prior probability that is a probability for each factor to occur;

a posterior probability calculating unit configured to calculate a posterior probability that is a probability for a certain event to be caused by a certain factor; and

an index calculating unit configured to multiply the posterior probability by a weighting coefficient relating to a signal-to-noise ratio gain value of a sensor measurement value, and calculate an index indicating an occurrence probability for each combination of the factors and the events.

A program according to the present disclosure causes a computer to execute the procedures of:

calculating, based on a factor table indicating an occurrence frequency of each of factors for each of events, a prior probability that is a probability for each factor to occur;

calculating a posterior probability that is a probability for a certain event to be caused by a certain factor; and

multiplying the posterior probability by a weighting coefficient relating to a signal-to-noise ratio gain value of a sensor measurement value, and calculating an index indicating an occurrence probability for each combination of the factors and the events.

According to the present disclosure, an anomaly factor estimation method and the like capable of improving the estimation accuracy for anomaly factors can be provided.

### BRIEF DESCRIPTION OF DRAWINGS

The disclosure will be described with reference to the accompanying drawings, wherein like numbers reference like elements.

FIG. 1 is a block diagram schematically illustrating a hardware configuration of an anomaly factor estimating device according to an embodiment.

FIG. 2 is a block diagram schematically illustrating a functional configuration of an anomaly factor estimating device according to an embodiment.

FIG. 3 is a flowchart for explaining an example of processing performed by an anomaly factor estimating device according to an embodiment.

FIG. 4 is a diagram illustrating an example of signal-to-noise ratio gain values acquired by an anomaly factor estimating device according to an embodiment.

FIG. 5 is a diagram illustrating an example of a sensor table used by an anomaly factor estimating device according to an embodiment.

FIG. 6 is a diagram illustrating an example of calculation results by an anomaly factor estimating device according to an embodiment.

FIG. 7 is a diagram illustrating an example of calculation results (weighting coefficients) by an anomaly factor estimating device according to an embodiment.

FIG. 8 is a diagram illustrating an example of extraction results based on a factor table by an anomaly factor estimating device according to an embodiment.

FIG. 9 is a diagram illustrating an example of calculation results of prior probabilities by an anomaly factor estimating device according to an embodiment.

FIG. 10 is a diagram illustrating an example of calculation results of likelihoods by an anomaly factor estimating device according to an embodiment.

FIG. 11 is a diagram illustrating an example of calculation results of posterior probabilities by an anomaly factor estimating device according to an embodiment.

FIG. 12 is a diagram illustrating an example of calculation results by an anomaly factor estimating device according to an embodiment.

FIG. 13 is a diagram illustrating an example of information outputted by an anomaly factor estimating device according to an embodiment.

### DESCRIPTION OF EMBODIMENTS

An embodiment will be described hereinafter with reference to the appended drawings. However, dimensions, materials, shapes, relative positions and the like of components described in the embodiments or illustrated in the drawings shall be interpreted as illustrative only and not intended to limit the scope of the invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance within a range in which it is possible to achieve the same function.

For instance, an expression of an equal state such as “same”, “equal”, “uniform” and the like shall not be construed as indicating only the state in which the feature is strictly equal, but also includes a state in which there is a tolerance or a difference within a range where it is possible to achieve the same function.

Further, for instance, an expression of a shape such as a rectangular shape, a cylindrical shape or the like shall not be construed as only the geometrically strict shape, but also includes a shape with unevenness, chamfered corners or the like within the range in which the same effect can be achieved.

On the other hand, an expression such as “comprise”, “include”, “have”, “contain” and “constitute” are not intended to be exclusive of other constituent elements.

### Configuration of Anomaly Factor Estimating Device

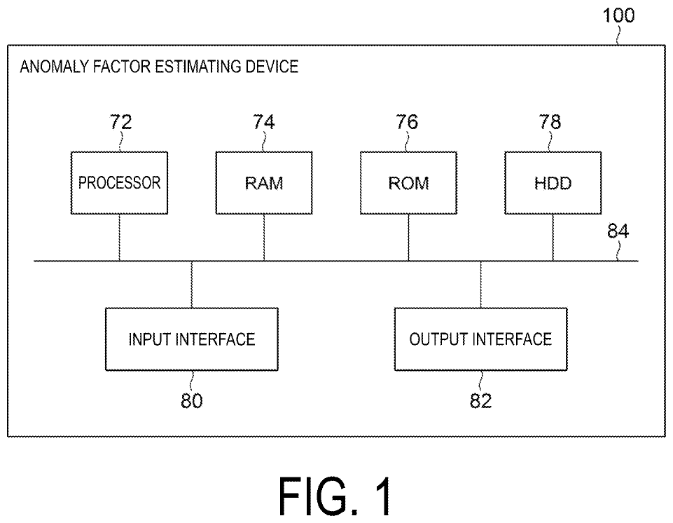

An overall configuration of an anomaly factor estimating device 100 according to an embodiment will be described. FIG. 1 is a block diagram schematically illustrating a hardware configuration of the anomaly factor estimating device 100 according to an embodiment. For example, the anomaly factor estimating device 100 is a device for acquiring sensor measurement values from a sensor (not illustrated) that performs measurement relating to an apparatus, a server device (not illustrated) that stores sensor measurement values, and the like, and estimating a factor for an abnormal event that occurs on the apparatus.

For example, as illustrated in FIG. 1, the anomaly factor estimating device 100 is configured using a computer, the computer including a processor 72 such as a central processing unit (CPU) or a graphics processing unit (GPU), a random access memory (RAM) 74, a read-only memory (ROM) 76, a hard disk drive (HDD) 78, an input interface 80, and an output interface 82, and these components being interconnected via a bus 84. The processor 72 of the anomaly factor estimating device 100 executes a program stored in a memory such as ROM or RAM, thereby realizing various types of functions described below.

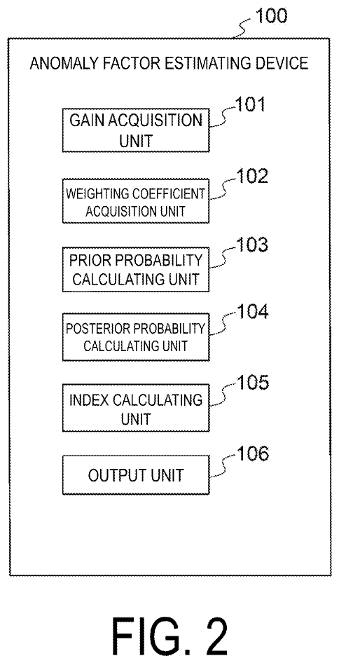

FIG. 2 is a block diagram schematically illustrating a functional configuration of the anomaly factor estimating device 100 according to an embodiment. As illustrated in FIG. 2, the anomaly factor estimating device 100 functionally includes a gain acquisition unit 101 configured to acquire signal-to-noise ratio gain values, a weighting coefficient acquisition unit 102 configured to acquire weighting coefficients, a prior probability calculating unit 103 configured to calculate prior probabilities, a posterior probability calculating unit 104 configured to calculate posterior probabilities, an index calculating unit 105 configured to calculate indexes, and an output unit 106 configured to output various types of information (including estimation results).

### Flow of Processing

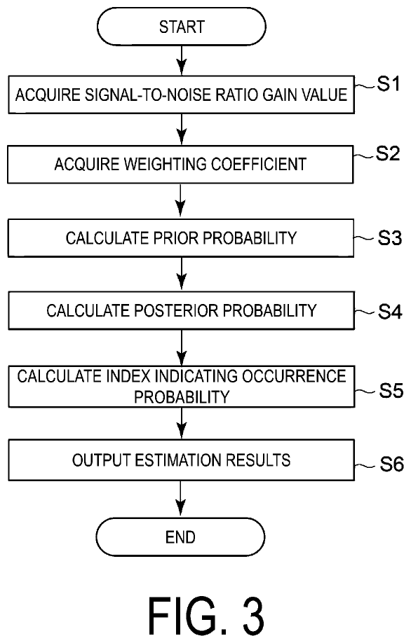

Hereinafter, the flow of processing performed by the anomaly factor estimating device 100 according to an embodiment will be described. FIG. 3 is a flowchart for explaining an example of processing performed by the anomaly factor estimating device 100 according to an embodiment.

As illustrated in FIG. 3, the gain acquisition unit 101 acquires a signal-to-noise ratio gain value of a sensor measurement value (step S1). Note that the gain acquisition unit 101 may be configured to monitor a Mahalanobis distance that is based on sensor measurement values, and obtain a signal-to-noise ratio gain value in cases where an abnormal event is detected based on the Mahalanobis distance. In this case, because anomaly factor estimation is performed in cases where an abnormal event is detected, computation processing that accompanies anomaly factor estimation can be reduced.

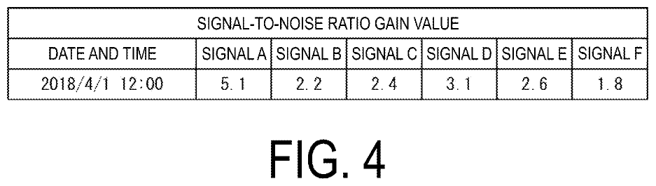

FIG. 4 is a diagram illustrating an example of signal-to-noise ratio gain values acquired by the anomaly factor estimating device 100 according to an embodiment. As illustrated in FIG. 4, for example, the gain acquisition unit 101 acquires a signal-to-noise ratio gain value for each signal from among a plurality of sensor measurement values (signals A to F) that are acquirable in time series. Note that while FIG. 4 illustrates a case in which signal-to-noise ratio gain values of one point in time are acquired, the gain acquisition unit 101 may acquire a signal-to-noise ratio gain value of each point in time at a plurality of points in time.

As illustrated in FIG. 3, the weighting coefficient acquisition unit 102 acquires a weighting coefficient relating to a signal-to-noise ratio gain value of a sensor measurement value (step S2). A weighting coefficient may be a signal-to-noise ratio gain value, or may be a value obtained after threshold processing has been performed on the signal-to-noise ratio gain value as illustrated in the following example.

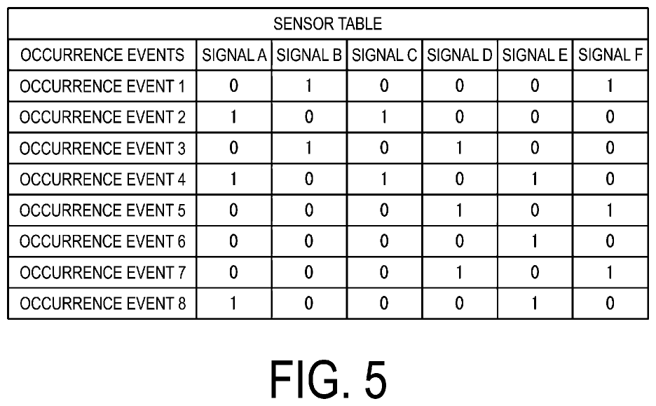

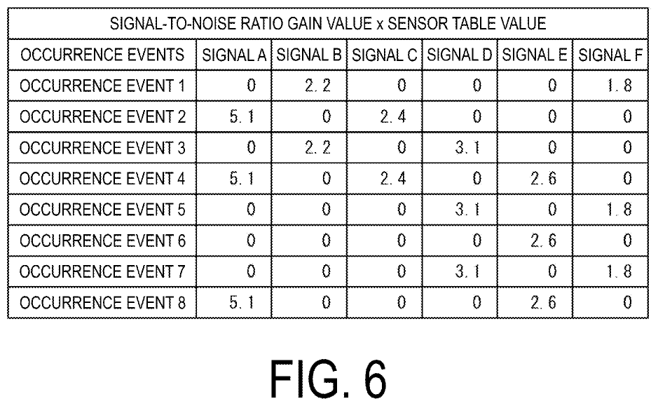

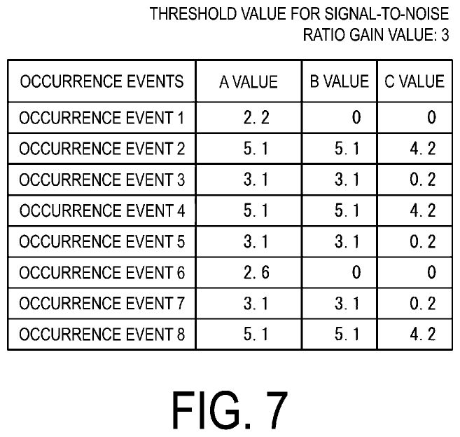

Here, an example in which a weighting coefficient is acquired by threshold processing will be described. FIG. 5 is a diagram illustrating an example of a sensor table used by the anomaly factor estimating device 100 according to an embodiment. FIG. 6 is a diagram illustrating an example of calculation results of the anomaly factor estimating device 100 according to an embodiment. FIG. 7 is a diagram illustrating an example of calculation results (weighting coefficients) of the anomaly factor estimating device 100 according to an embodiment.

The weighting coefficient acquisition unit 102 may use the sensor table illustrated in FIG. 5 for calculating weighting coefficients. The sensor table is information that indicates which signal is associated with which occurrence event. In the sensor table, for example, the signal A takes a value of 1 for the occurrence events 2, 4, and 8 because the signal A is related thereto, while the signal A takes a value of 0 for the other occurrence events because the signal A is not related thereto. The relationship is indicated in this manner in binary values of 1 and 0. Note that the weighting coefficient acquisition unit 102 is not limited to configurations in which a sensor table is used. The weighting coefficient acquisition unit 102 may be configured to extract occurrence events related to each signal without using a sensor table.

Occurrence events include, for example, an axial vibration of a gas turbine and an abnormal increase in an exhaust gas temperature. Factors include, for example, as far as an increase in the exhaust gas temperature is concerned, shortage in cooling air and sensor malfunction. Narrowing down in this manner is beneficial because while some occurrence events and factors are in an obvious one-to-one correspondence, there are also events that occur due to combined factors.

The weighting coefficient acquisition unit 102 may acquire the calculation results shown in FIG. 6 by multiplying the values of the sensor table shown in FIG. 5 by the signal-to-noise ratio gain values shown in FIG. 4. For example, in the calculation results shown in FIG. 6, the signal A takes a value of zero for the occurrence events 1, 3, and 5 to 7 because its value is given by the product of 0 and 5.1, while the signal A takes a value of 5.1 for the occurrence events 2, 4, and 8 because its value is given by the product of 1 and 5.1. A similar computation is also performed for the signals B to F by the products of the signal-to-noise ratio gain values shown in FIG. 4 and the values of 1 or 0 in the sensor table shown in FIG. 5.

The weighting coefficient acquisition unit 102 may acquire A values from the calculation results shown in FIG. 6. The A value is the maximum value of the signal-to-noise ratio gain values for each occurrence event. For example, in the occurrence event 1 illustrated in FIG. 6, the calculated value corresponding to the signal B is 2.2, the calculated value corresponding to the signal F is 1.8, and the calculated values corresponding to the other signals are 0. In this case, as shown in FIG. 7, the A value of the occurrence event 1 is 2.2. The A values of the other occurrence events are also acquired in the same manner.

As illustrated in FIG. 7, the weighting coefficient acquisition unit 102 may acquire B values corresponding to the A values by using a threshold value for signal-to-noise ratio gain values. In the example shown in FIG. 7, the threshold value for signal-to-noise ratio gain values is 3. The threshold value for signal-to-noise ratio gain values is set to a value that serves as a discrimination reference for estimating that a signal-to-noise ratio gain value contributed to an increase in the Mahalanobis distance. The threshold value for signal-to-noise ratio gain values may be a value manually entered by a user based on knowledge, or may be a value that is automatically computed by a statistical approach. In the example shown in FIG. 7, the same threshold value of 3 is set for all events. However, a different threshold value may be set for each event.

The B value is a value obtained by filtering the A value by a threshold value for signal-to-noise ratio gain values. Specifically, the B value is a value obtained by setting the A value to 0 if the A value is equal to or less than the threshold value for signal-to-noise ratio gain values, and using the A value as is if the A value is greater than the threshold value for signal-to-noise ratio gain values. For example, the occurrence event 1 has a B value of 0 because the A value is 2.2, which is equal to or less than 3; and the occurrence event 2 has a B value of 5.1 because the A value is 5.1, which is greater than 3.

The weighting coefficient acquisition unit 102 may acquire a C value of each occurrence event using the B value as shown in FIG. 7. The C value is a weighting coefficient. As a weighting coefficient, the C value may be a coefficient set based on an excess amount of a signal-to-noise ratio gain value relative to a threshold value. For example, in the illustrated example, the C values are calculated by subtracting the threshold value for signal-to-noise ratio gain values from the B values and multiplying the subtracted values by 2. However, the computation formula for C values is not limited to this, and can be changed as appropriate.

An example in which a weighting coefficient is acquired by threshold processing has been described above. However, the procedure for acquiring the weighting coefficient by threshold processing is not limited to the above-described example. For example, the weighting coefficient acquisition unit 102 may perform threshold processing on the signal-to-noise ratio gain values shown in FIG. 4 before multiplying the processed values by the values in the sensor table shown in FIG. 5. Furthermore, the weighting coefficient acquisition unit 102 does not have to be configured to calculate the B values from the A values and then calculate the C values from the B values as shown in FIG. 7, but may be configured to calculate the C values directly from the A values and, if the calculation results in a negative value, set the C value to 0. In this manner, it is possible to obtain the same results even when the procedure is changed.

Using such weighting coefficients in the computation of the index described below cannot only allow computation to be performed solely for any event and any factor that have a signal-to-noise ratio gain value greater than a reference value, but also allow the size relationship of the magnitude of signal-to-noise ratio gain values to be reflected in the weighting coefficients and these weighting coefficients to be used for computation. Therefore, the size relationship of the magnitude of signal-to-noise ratio gain values can be made conspicuous.

As illustrated in FIG. 3, the prior probability calculating unit 103 calculates a prior probability that is a probability for each factor to occur (step S3). The prior probability calculating unit 103 calculates the prior probabilities based on a factor table indicating the occurrence frequency of each of factors for each of events.

Information contained in the factor table also includes information such as events that rarely occur, special events, and events whose occurrence factors are unknown. When such information is used in estimating anomaly factors, there is a risk that the accuracy may decrease. Therefore, the prior probability calculating unit 103 may be configured to extract and use, from among the information contained in the factor table, information relating to any event and any factor that are associated with a sensor measurement value having a greater signal-to-noise ratio gain value than a reference value. In this case, high accuracy is achieved because prior probabilities and posterior probabilities can be calculated by narrowing down the information contained in the factor table to information relating to any event and any factor that are associated with a sensor measurement value having a greater signal-to-noise ratio gain value than the reference value. Note that the prior probability calculating unit 103 may be configured to calculate prior probabilities directly from the factor table without performing such extraction.

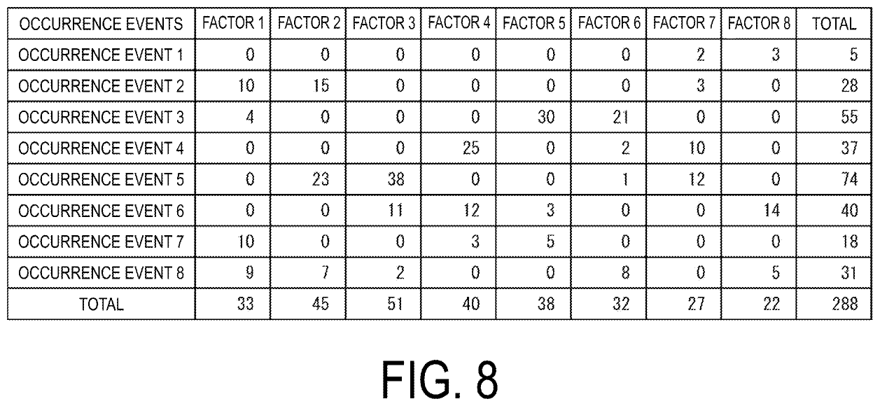

FIG. 8 is a diagram illustrating an example of extraction results based on a factor table by the anomaly factor estimating device 100 according to an embodiment. In this example, six sensors (signals) have a signal-to-noise ratio gain as shown in FIG. 4, and the occurrence events related to these six signals (signals A to F) are the eight occurrence events 1 to 8 as shown in FIG. 5. These eight occurrence events together with their respective factors are extracted from the factor table to constitute FIG. 8. In this manner, the prior probability calculating unit 103 extracts a number of occurrence events and their respective factors from the factor table that associates the occurrence events with the factors. In FIG. 8, for example, the occurrence event 1 occurred twice due to the factor 7, three times due to the factor 8, and zero time due to the factors 1 to 6. In this manner, the extraction results shown in FIG. 8 indicate the number of occurrences of each occurrence event on a factor-by-factor basis, and also indicate subtotal values for each of these factors (for example, the number of occurrences for the factor 7 is 27) and the total value obtained by totaling the subtotal values.

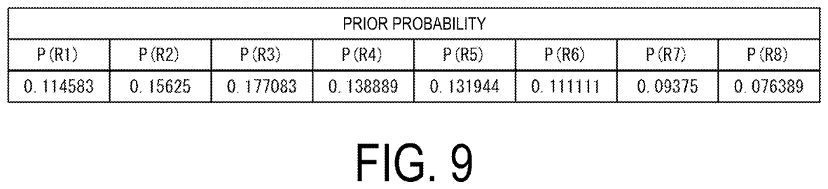

FIG. 9 is a diagram showing an example of calculation results of prior probabilities by an anomaly factor estimating device 100 according to an embodiment. The R1 to R8 shown in FIG. 9 correspond to the factors 1 to 8 shown in FIG. 8. P stands for probability. For example, P(R1) stands for the probability for the factor 1 to occur (the prior probability of the factor 1). A prior probability is calculated by dividing the subtotal value for each factor indicated in the extraction results shown in FIG. 8 by the total value. For example, the prior probability P(R8) for the factor 8 is a value obtained by dividing a subtotal value of 22 by a total value of 288, which results in 0.076389. The prior probability calculating unit 103 performs such calculation for each factor.

As illustrated in FIG. 3, the posterior probability calculating unit 104 calculates a posterior probability that is a probability for a certain event to be caused by a certain factor (step S4). The posterior probability calculating unit 104 may calculate the posterior probability P(Rj|Fi) using the prior probability for each factor and the likelihood P(Fi|Rj) that is the probability for each event Fi to occur due to each factor Rj. In this case, posterior probabilities can be easily calculated using prior probabilities and likelihoods.

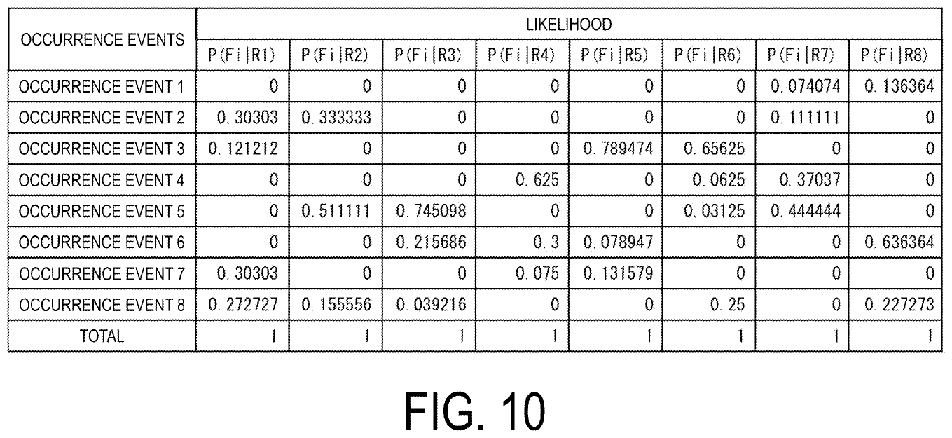

FIG. 10 is a diagram illustrating an example of calculation results of the likelihood P(Fi|Rj) by the anomaly factor estimating device 100 according to an embodiment. The Fi shown in FIG. 10 stands for any occurrence event i from among the occurrence events 1 to 8. For example, P(Fi|R1) stands for the likelihood for the event Fi to occur due to the factor R1. For example, the likelihood for the event F2 (occurrence event 2) to occur due to the factor R1 is 0.30303.

The likelihood is calculated, in the extraction results of the factor table shown in FIG. 8, by dividing the number of occurrences that the certain event Fi occurred due to the certain factor Ri by a subtotal value for each factor. For example, the likelihood P(F1|R7) is a value obtained by dividing the number of occurrences that the event Fi occurred due to the factor R7, which is 2, by a subtotal value of 27, which results in 0.074074 as shown in FIG. 10. The posterior probability calculating unit 104 may compute such likelihood for each combination of the events and the factors, as shown in FIG. 10.

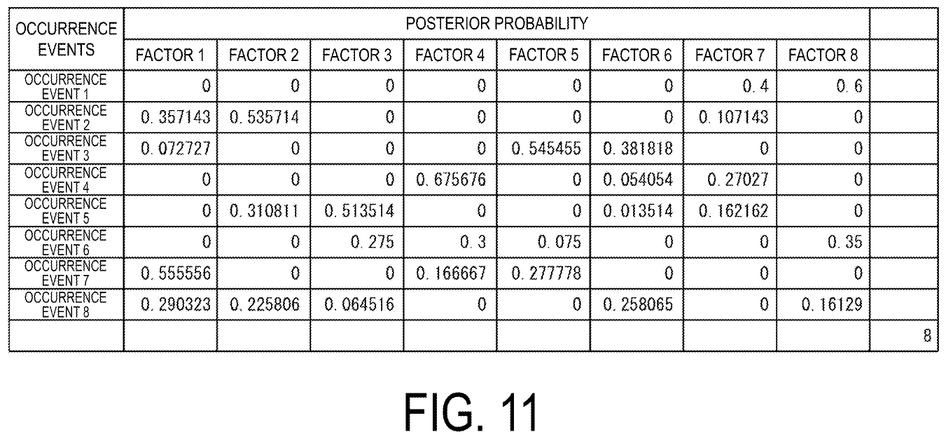

The posterior probability calculating unit 104 may calculate posterior probabilities using such likelihoods. FIG. 11 is a diagram showing an example of calculation results of the posterior probability P(Rj|Fi) by the anomaly factor estimating device 100 according to an embodiment. The posterior probability (Rj|Fi) that is the probability for the certain event Fi to be caused by the certain factor Rj is calculated by dividing the product of the certain likelihood P(Fi|Rj) and the certain prior probability P(Rj) by the sum total of the products of each likelihood and each prior probability that correspond to the factor Rj.

The posterior probability P(Rj|Fi) in cases where there are n factors is calculated from the following formula:

P(Rj|Fi)=P(Fi|Rj)·P(Rj)/(P(Fi|R1)·P(R1)+P(Fi|R2)·P(R2)+ . . . +P(Fi|Rn)·P(Rn)).

In this manner, posterior probabilities are computed by a mathematical formula that also takes into account cases where a certain event occurs due to a plurality of factors (R1 to Rn).

Note that, for example, in FIG. 11, the posterior probability P(R1|F2) for the occurrence event 2 to be caused by the factor 1 is determined by the following formula:

P(R1|F2)=P(F2|R1)·P(R1)/(P(F2|R1)·P(R1)+P(F2|R2)·P(R2)+P(F2|R3)·P(R3)+P(F2|R4)·P(R4)+P(F2|R5)·P(R5)+P(F2|R6)·P(R6)+P(F2|R7)·P(R7)+P(F2|R8)·P(R8))=0.357143.

Note that in FIG. 11, subtotaling posterior probabilities for each factor or each event, and totaling these subtotal values results in a total value of 8, which is the same value as the number of occurrences, as shown in the lower right in the figure.

As illustrated in FIG. 3, the index calculating unit 105 calculates indexes indicating occurrence probabilities (step S5). The index calculating unit 105 multiplies the posterior probability calculated by the posterior probability calculating unit 104 by a weighting coefficient (C value) acquired by the weighting coefficient acquisition unit 102, and calculates an index indicating an occurrence probability for each combination of the factors and the occurrence events. An index indicating an occurrence probability may be a preliminary numerical value before the normalization, or may be an occurrence probability after the normalization.

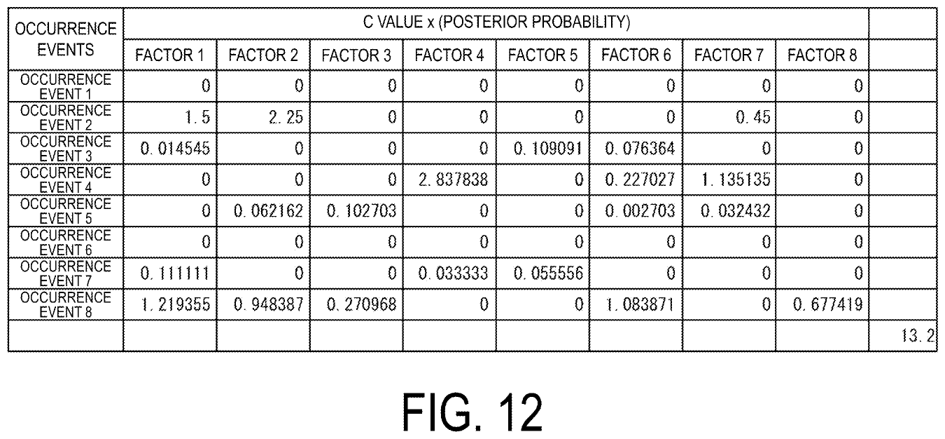

First, specific examples of the former will be described. FIG. 12 is a diagram illustrating an example of calculation results by the anomaly factor estimating device 100 according to an embodiment. For each combination of the factors and the occurrence events, there is shown an index indicating an occurrence probability, which is a value obtained by multiplying the posterior probability calculated by the posterior probability calculating unit 104 by the weighting coefficient (C value) acquired by the weighting coefficient acquisition unit 102.

For example, an index indicating the occurrence probability for the occurrence event 1 to occur due to the factor 2 is 0 because it is the product of the posterior probability, which is 0, and the C value, which is 0. An index indicating the occurrence probability for the occurrence event 2 to occur due to the factor 2 is 2.25 because it is the product of the posterior probability, which is 0.53714, and the C value, which is 4.2. In this manner, an index indicating each of the occurrence probabilities is calculated by multiplying the C value corresponding to each occurrence event shown in FIG. 7 by the value in the table of posterior probability shown in FIG. 11.

Note that in FIG. 12, subtotaling the index indicating an occurrence probability for each factor or each event, and totaling these subtotal values results in a total value of 13.2, as shown in the lower right in the figure. This total value is affected by the weighting coefficient, and so may be a value different from the number of occurrence events. In this example as well, the total value is not 8 but 13.2.

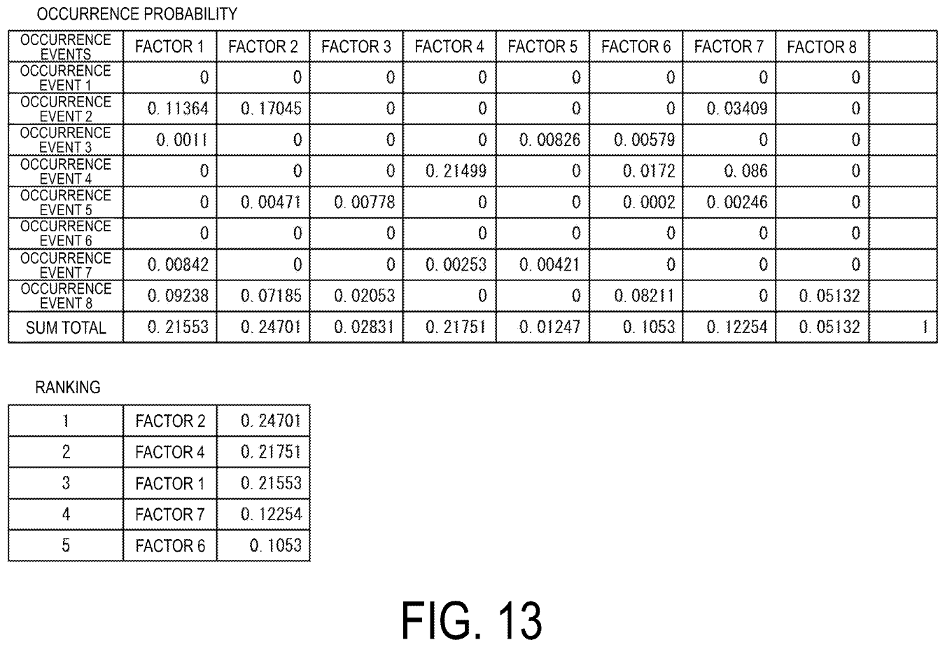

Next, specific examples of the latter will be described. FIG. 13 is a diagram illustrating an example of information output by the anomaly factor estimating device 100 according to an embodiment. The occurrence probabilities shown in FIG. 13 indicate the occurrence probabilities that have been normalized by dividing each of the values shown in FIG. 12 by a total value of 13.2. For example, in FIG. 13, totaling the subtotal values of the occurrence probabilities for each factor results in 1, that is, 100%, as shown in the lower right in the figure in the table of occurrence probability. In this manner, an index indicating an occurrence probability is the occurrence probability of each factor when a certain event occurred, and the occurrence probability of each factor may be calculated by dividing a subtotal value that is obtained by subtotaling multiplied values between the posterior probabilities and the weighting coefficients for each factor by a total value that is a value obtained by totaling these subtotal values for all of the factors. In this case, the occurrence probability of each factor can be ascertained.

As illustrated in FIG. 3, the output unit 106 outputs estimation results (step S6). For example, as shown in FIG. 13, the output unit 106 may rank the occurrence probability of each factor in descending order, and output high-ranking factors. In this case, due to what factor these abnormal events occur can be easily ascertained. For example, it can be seen that the probability for these events to occur due to the factor 2 ranks the highest at 24.7%. Note that the output unit 106 may output only one, the highest-ranking factor, or may output a plurality of factors selected in descending order from the highest. Furthermore, the output unit 106 may output indexes indicating occurrence probabilities as estimation results, as shown in FIG. 12 or FIG. 13.

The flow of processing performed by the anomaly factor estimating device 100 according to an embodiment has been described above with reference to FIG. 3. Note that part of the processing illustrated in FIG. 3 may be performed by a user. Furthermore, the order of processing illustrated in FIG. 3 may be changed. For example, steps S3 and S4 may be performed prior to steps S1 and S2. Because prior probabilities, likelihoods, and posterior probabilities can be calculated from a factor table rather than from sensor measurement values, indexes indicating occurrence probabilities may be calculated by calculating prior probabilities, likelihoods, and posterior probabilities in advance and then acquiring signal-to-noise ratio gain values and weighting coefficients.

Furthermore, the anomaly factor estimating device 100 may calculate indexes indicating occurrence probabilities using a table indicating posterior probabilities that have been acquired in advance, without using a factor table or calculating prior probabilities, likelihoods, and posterior probabilities. In this case, steps S3 and S4 may be omitted. However, the factor table and tables indicating prior probabilities, likelihoods, posterior probabilities, and the like are preferably updated to reflect the most recent information. Such update processing may be performed automatically by the anomaly factor estimating device 100 or may be performed by the user's manual input. In cases where there are frequent updates, it is preferable to calculate prior probabilities, likelihoods, and posterior probabilities each time an update is performed, as illustrated in FIG. 3.

The anomaly factor estimating device 100 may be configured to select a factor table to use in computation from among a plurality of factor tables, each of the plurality of factor tables being for each process. For example, apparatuses or systems including an apparatus may exhibit different behavior from the normal operating state when they are in transient operating states such as startup time and stoppage time, or when they are in special operating states where a measurement value such as temperature, pressure, and vibration is lower or higher than the normal by 2σ (reference dispersion value), for example. In this case, occurrence events and factors vary depending on the process of the operating state. Therefore, for example, it may be possible to improve the estimation accuracy by creating a factor table for each process such as startup time, operation time, and stoppage time, and selecting and using a factor table corresponding to the process of the time when an abnormal event occurred.

The present disclosure is not limited to the above-described embodiments and also includes modifications of the above-described embodiments as well as appropriate combinations of a plurality of the embodiments.

### SUMMARY

The contents described in each of the above embodiments are understood as follows, for example.

(1) An anomaly factor estimation method according to the present disclosure includes the steps of:

calculating, based on a factor table indicating an occurrence frequency of each of factors for each of events, a prior probability that is a probability for each factor to occur;

calculating a posterior probability that is a probability for a certain event to be caused by a certain factor; and

multiplying the posterior probability by a weighting coefficient relating to a signal-to-noise ratio gain value of a sensor measurement value, and calculating an index indicating an occurrence probability for each combination of the factors and the events.

According to the method described above, an index indicating an occurrence probability is calculated for each combination of the factors and the events based on posterior probability. Posterior probabilities are computed by a mathematical formula that also takes into account cases where a certain event occurs due to a plurality of factors. Therefore, it is possible to estimate anomaly factors based on computation that takes into account interaction among a plurality of factors (relative evaluation) rather than based on computation results for each factor (absolute evaluation). Accordingly, it is possible to improve the estimation accuracy for anomaly factors.

(2) In some embodiments, in the method described in (1) above,

in calculating the prior probability, from among information contained in the factor table, information relating to the event and the factor that are associated with a sensor measurement value having a greater signal-to-noise ratio gain value than a reference value is extracted and used.

Information contained in the factor table also includes information such as events that rarely occur, special events, and events whose occurrence factors are unknown. When such information is used in estimating anomaly factors, there is a risk that the accuracy may decrease. In this regard, according to the method described above, high accuracy is achieved because prior probabilities and posterior probabilities can be calculated by narrowing down the information contained in the factor table to information relating to any event and any factor that are associated with a sensor measurement value having a greater signal-to-noise ratio gain value than the reference value.

(3) In some embodiments, in the method described in (1) or (2) above,

in calculating the posterior probability, the posterior probability is calculated using the prior probability of each factor and a likelihood that is a probability for each event to occur due to each factor.

According to the method described above, posterior probabilities can be easily calculated using prior probabilities and likelihoods.

(4) In some embodiments, in the method described in any one of (1) to (3) above,

the weighting coefficient is a coefficient set based on an excess amount of the signal-to-noise ratio gain value relative to a threshold value.

According to the method described above, not only is computation performed solely for any event and any factor that have a signal-to-noise ratio gain value greater than a reference value, but also the size relationship of the magnitude of signal-to-noise ratio gain values is reflected in the weighting coefficients and these weighting coefficients are used for computation. Therefore, the size relationship of the magnitude of signal-to-noise ratio gain values can be made conspicuous.

(5) In some embodiments, in the method described in any one of (1) to (4) above,

the index indicating the occurrence probability is an occurrence probability of each factor when a certain event occurred; and

the occurrence probability of each factor is calculated by dividing a subtotal value that is obtained by subtotaling a multiplied value between the posterior probability and the weighting coefficient for each factor by a total value that is a value obtained by totaling the subtotal values for all of the factors.

According to the method described above, occurrence probabilities of each factor can be ascertained.

(6) In some embodiments, the method described in (5) above further includes the step of:

ranking the occurrence probability of each factor in descending order and outputting high-ranking factors.

According to the method described above, due to what factor these abnormal events occur can be easily ascertained.

(7) In some embodiments, the method described in any one of (1) to (6) further includes the steps of:

monitoring a Mahalanobis distance that is based on the sensor measurement value; and

acquiring the signal-to-noise ratio gain value in cases where an abnormal event is detected based on the Mahalanobis distance.

According to the method described above, because anomaly factor estimation is performed in cases where an abnormal event is detected, computation processing that accompanies anomaly factor estimation can be reduced.

(8) In some embodiments, the method described in any one of (1) to (7) above further includes the step of:

selecting the factor table to use in computation from among a plurality of factor tables, each of the plurality of factor tables being for each process.

According to the method described above, it may be possible to improve the estimation accuracy by selecting and using a factor table corresponding to the process of the time when an abnormal event occurred.

(9) An anomaly factor estimating device (100) according to the present disclosure includes:

a prior probability calculating unit (103) configured to calculate, based on a factor table indicating an occurrence frequency of each of factors for each of events, a prior probability that is a probability for each factor to occur;

a posterior probability calculating unit (104) configured to calculate a posterior probability that is a probability for a certain event to be caused by a certain factor; and

an index calculating unit (105) configured to multiply the posterior probability by a weighting coefficient relating to a signal-to-noise ratio gain value of a sensor measurement value, and calculate an index indicating an occurrence probability for each combination of the factors and the events.

According to the configuration described above, the anomaly factor estimating device (100) calculates an index indicating an occurrence probability for each combination of the factors and the events based on posterior probability. Posterior probabilities are computed by a mathematical formula that also takes into account cases where a certain event occurs due to a plurality of factors. Therefore, it is possible to estimate anomaly factors based on computation that takes into account interaction among a plurality of factors (relative evaluation) rather than based on computation results for each factor (absolute evaluation). Accordingly, it is possible to improve the estimation accuracy for anomaly factors.

(10) A program according to the present disclosure causes a computer to execute the procedures of:

calculating, based on a factor table indicating an occurrence frequency of each of factors for each of events, a prior probability that is a probability for each factor to occur;

calculating a posterior probability that is a probability for a certain event to be caused by a certain factor; and

multiplying the posterior probability by a weighting coefficient relating to a signal-to-noise ratio gain value of a sensor measurement value, and calculating an index indicating an occurrence probability for each combination of the factors and the events.

According to the program described above, an index indicating an occurrence probability is calculated for each combination of the factors and the events based on posterior probability. Posterior probabilities are computed by a mathematical formula that also takes into account cases where a certain event occurs due to a plurality of factors. Therefore, it is possible to estimate anomaly factors based on computation that takes into account interaction among a plurality of factors (relative evaluation) rather than based on computation results for each factor (absolute evaluation). Accordingly, it is possible to improve the estimation accuracy for anomaly factors.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. An anomaly factor estimation method, comprising the steps of:
calculating, based on a factor table indicating an individual occurrence frequency of a plurality of factors for a plurality of events, a prior probability that is a probability for each of the plurality of factors to occur;
calculating a posterior probability that is a probability for a certain event to be caused by a certain factor of the plurality of factors; and
multiplying the posterior probability by a weighting coefficient relating to a signal-to-noise ratio gain value of a sensor measurement value, and calculating an index indicating an occurrence probability for individual combination of the plurality of factors and the plurality of events.

2. The anomaly factor estimation method according to claim 1,
wherein in the step of calculating the prior probability, from among information contained in the factor table, information relating to the plurality of events and the plurality of factors that are associated with the sensor measurement value is extracted and used, the sensor measurement value having a greater signal-to-noise ratio gain value than a reference value.

3. The anomaly factor estimation method according to claim 1,
wherein in the step of calculating the posterior probability, the posterior probability is calculated using the prior probability of each of the plurality of factors and a likelihood that is a probability for each of the plurality of events to occur due to each of the plurality of factors.

4. The anomaly factor estimation method according to claim 1,
wherein the weighting coefficient is a coefficient set based on an excess amount of the signal-to-noise ratio gain value relative to a threshold value.

5. The anomaly factor estimation method according to claim 1,
wherein the index indicating the occurrence probability is an occurrence probability of each of the plurality of factors when a certain event has occurred, and
the occurrence probability of each of the plurality of factors is calculated by dividing a subtotal value that is obtained by subtotaling a multiplied value between the posterior probability and the weighting coefficient for each of the plurality of factors by a total value that is a value obtained by totaling the subtotal values for all of the plurality of factors.

6. The anomaly factor estimation method according to claim 5, further comprising the step of:
ranking the occurrence probability of each of the plurality of factors in descending order and outputting a high-ranking factor among the plurality of factors.

7. The anomaly factor estimation method according to claim 1, further comprising the steps of:
monitoring a Mahalanobis distance that is based on the sensor measurement value; and
acquiring the signal-to-noise ratio gain value in a case where an abnormal event among the plurality of events is detected based on the Mahalanobis distance.

8. The anomaly factor estimation method according to claim 1, further comprising the step of:
selecting the factor table to use in computation from among a plurality of the factor tables, each of the plurality of factor tables being for an individual process.

9. An anomaly factor estimating device, comprising:
a prior probability calculating unit configured to calculate, based on a factor table indicating an individual occurrence frequency of a plurality of factors for a plurality of events, a prior probability that is a probability for each of the plurality of factors to occur;
a posterior probability calculating unit configured to calculate a posterior probability that is a probability for a certain event among the plurality of events to be caused by a certain factor among the plurality of factors; and
an index calculating unit configured to multiply the posterior probability by a weighting coefficient relating to a signal-to-noise ratio gain value of a sensor measurement value, and calculate an index indicating an occurrence probability for individual combination of the plurality of factors and the plurality of events.

10. A non-transitory computer readable storage medium storing a program for causing a computer to execute the procedures of:
calculating, based on a factor table indicating an individual occurrence frequency of a plurality of factors for a plurality of events, a prior probability that is a probability for each of the plurality of factors to occur;
calculating a posterior probability that is a probability for a certain event among the plurality of events to be caused by a certain factor among the plurality of factors; and
multiplying the posterior probability by a weighting coefficient relating to a signal-to-noise ratio gain value of a sensor measurement value, and calculating an index indicating an occurrence probability for individual combination of the plurality of factors and the plurality of events.
